(19) United States
(12) Patent Application Publication
(10) Pub. No.: US 2007/0169152 A1
(43) Pub. Date: Jul. 19, 2007

(54) Data and wireless frame alignment for error reduction

(76) Inventors: Daniel Roodnick, (US); Gordon Ryley, (US); Sukhdeep Hundal, (US)

Correspondence Address: PAUL, HASTINGS, JANOFSKY & WALKER LLP, P.O. BOX 919092, SAN DIEGO, CA, 92191-9092, US

(21) Appl. No.: 11/642,738

(22) Filed: Dec. 21, 2006

Related U.S. Application Data
(60) Provisional application No. 60/754,621, filed on Dec. 30, 2005.

(51) Int. Cl. H04N 7/16

(52) U.S. Cl. 725/62; 348/14.01

(57) ABSTRACT

A method for reducing errors in streaming data over a wireless link that aligns data frames with wireless packets. The method is especially suitable for a wireless link that requires a uniform packet size and prohibits re-transmission of packets. One embodiment aligns a start of a data frame with a first wireless packet, transmits a beginning portion of the data frame in the first wireless packet over a wireless link, inserts into a second wireless packet an ending portion of the data frame along with fill data sufficient to fill the second wireless packet, and transmits the second wireless packet over the wireless link. A further embodiment includes synchronization markers at the start of the beginning portion and the ending portion.

This application claims the benefit of U.S. Provisional Application No. 60/754,621, filed Dec. 30, 2005, which is herein incorporated by reference in its entirety.

### BACKGROUND

### Background of the Invention

In a wireless system in which the data is divided up into packets or frames for data delivery, there are times when packets/frames over the link are lost or partially lost. For example, in video encoding schemes such as H-263 or MPEG-4, the complete picture (I-frame) is not sent all at one time. The frames in between (P-frames) only carry the difference information from the previous frame. At the decoder end, the display is updated based on the difference information. Under these circumstances, a number of video frames following a frame with an error will start accumulating errors because the difference information is superimposed on top of a received error.

One way to recover from this error situation is to send a new complete picture (I-frame) or reference frame. This approach is not always possible, however, because reference frames are generally larger and require higher bandwidth to transmit. In a video streaming application, it is also not always possible to re-transmit frames that are received in error. Re-transmission requires a control channel to identify which frames/partial frames need to be re-transmitted. Allowing for re-transmission may also introduce an unacceptable delay in real-time video streaming applications. It is therefore desirable to minimize the number of video frames received in error.

FIGS. 1 and 2 illustrate typical conditions under which errors occur. FIG. 1 shows a wireless packet carrying only a portion of a video frame. FIG. 2 shows a wireless packet carrying portions of multiple video frames.

FIG. 1: Wireless Packet Carrying a Partial Video Frame

Because video frames can be larger than the capacity of a single radio packet, the wireless packets may only carry a part of a video frame. As shown in FIG. 1, if wireless packet 3 is lost or partially lost, then the decoder will have difficulty correctly decoding video frame 2.

FIG. 2: Wireless Packet Carrying Parts of Multiple Video Frames

Because the sizes of the radio packets and video frames are not identical, it is also possible that one wireless packet/frame may carry parts of more than one video frame (data belonging to two different video frames). As shown in FIG. 2, if wireless packet 2 is lost or partially lost, then the decoder will have difficulty correctly decoding video frame I and video frame 2.

### SUMMARY OF THE INVENTION

An embodiment of the present invention provides a method for reducing errors in streaming data over a wireless link that aligns data frames with wireless packets. A data frame is divided into a plurality of data frame portions including a first data frame portion and an ending data frame portion. The first data frame portion comprises the temporal beginning of the data frame. The first data frame portion is inserted into a first wireless packet and fills the first wireless packet. The first wireless packet is transmitted over the wireless link. The ending data frame portion is inserted into a second wireless packet. Fill data is inserted into the second wireless packet sufficient to fill the second wireless packet if the ending data frame portion by itself does not fill the second wireless packet. Then, the second wireless packet is transmitted over the wireless link. In a further aspect of the present invention, a video frame has a synchronization marker aligned with its corresponding wireless packet.

Another embodiment of the present invention reduces errors in streaming data over a wireless link by aligning a start of a data frame with a first wireless packet, transmitting a beginning portion of the data frame in the first wireless packet over the wireless link, inserting into a second wireless packet an ending portion of the data frame along with fill data sufficient to fill the second wireless packet, and transmitting the second wireless packet over the wireless link.

Another embodiment of the present invention reduces errors in streaming video data over a wireless link by aligning a start of a video frame with a start of a first wireless packet, transmitting over the network a beginning portion of the video frame in a first wireless packet, inserting an ending portion of the video frame into a second wireless packet, inserting fill data into a second wireless packet sufficient to fill the second wireless packet, and transmitting over the wireless link the second wireless packet containing the ending portion of the video frame and the fill data.

The data streaming schemes of the present invention can require wireless packets transmitted over the wireless link to be of a uniform size and can prohibit re-transmission of wireless packets over the wireless link. The data frame can be greater in size than the uniform size.

### BRIEF DESCRIPTION OF THE DRAWINGS

FIG. 1 is a schematic diagram that illustrates a data transmission in which a wireless packet carries a portion of a video frame.

FIG. 2 is a schematic diagram that illustrates a data transmission in which a wireless packet carries portions of two different video frames.

FIG. 3 is a schematic diagram that illustrates a method for reducing errors in the transmission of video images, in which video frames are aligned with wireless packets, according to an embodiment of the present invention.

FIG. 4 is a schematic diagram that illustrates a method for reducing errors in the transmission of video images, in which video frames with synchronization markers are aligned with wireless packets, according to another embodiment of the present invention.

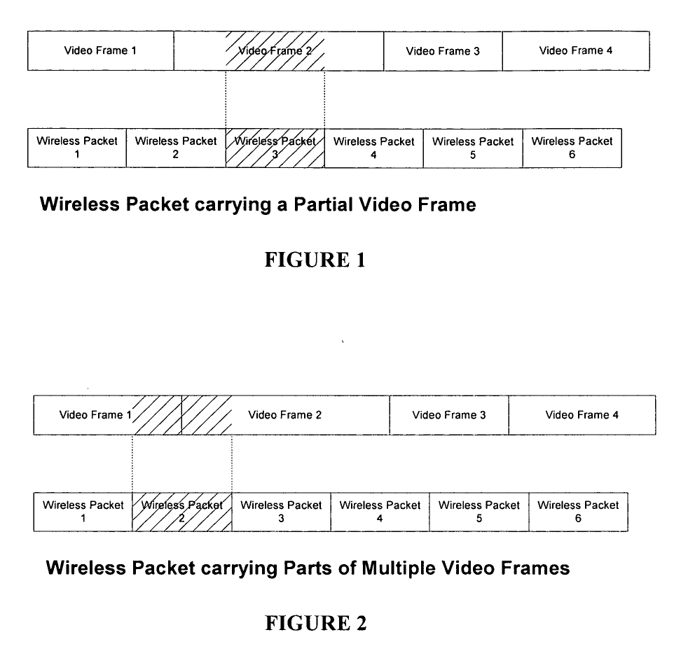

### DETAILED DESCRIPTION OF THE INVENTION

An embodiment of the present invention reduces the impact of error propagation on the transmission of data across a wireless link, such as in the streaming of real-time video images.

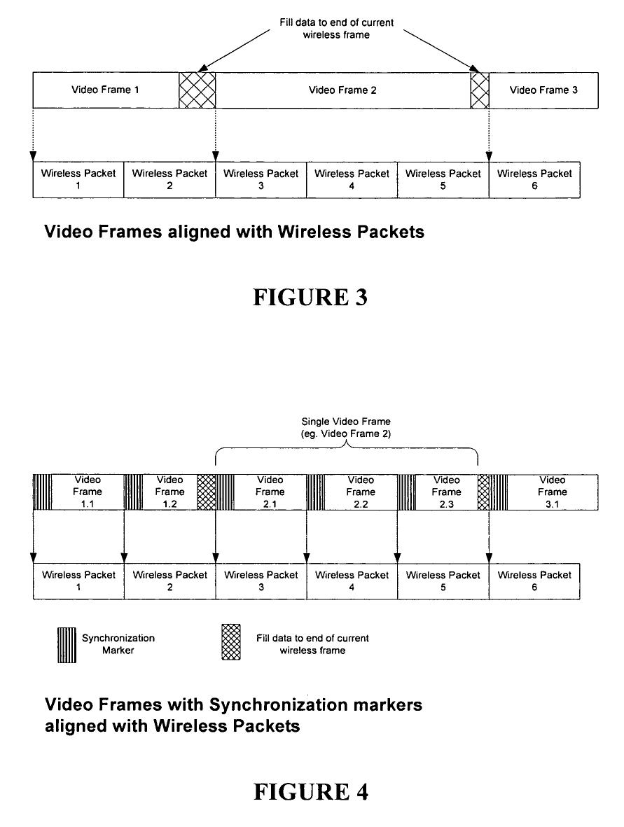

FIG. 3 illustrates an embodiment of the present invention that reduces the impact of error propagation on the transmission of video images across a wireless link by aligning the video frames with wireless packets and inserting fill data as necessary to align the end of the last wireless packet within a video frame with the end of the video frame. The beginning and end of a video frame are aligned with the wireless link packet boundaries. As shown in FIG. 3, if a wireless packet were lost or partially lost, then a decoder would only have difficulty correctly decoding a single video frame.

With reference to FIG. 3, in an embodiment of the present invention, a data frame, such as video frame 1, is divided into a plurality of data frame portions, including a first data frame portion and an ending data frame portion. The first data frame portion comprises the temporal beginning of the data frame. The first data frame portion is inserted into a first wireless packet and fills the first wireless packet. The first wireless packet is transmitted over a wireless link. The ending data frame portion is inserted into a second wireless packet. If the ending data frame portion by itself does not fill the second wireless packet, fill data is inserted into the second wireless packet sufficient to fill the second wireless packet. The second wireless packet is then transmitted over the wireless link.

As shown in FIG. 3, a data frame can be divided into more than two wireless packets, as is shown with video frame 2. In that case, for example, the data frame is divided into a first data frame portion and an ending data frame portion (as described in the preceding paragraph), as well as an intermediate data frame portion. The intermediate data frame portion is inserted into a third wireless packet (e.g., wireless packet 4) and fills the third wireless packet. The third wireless packet is transmitted over the wireless link. The third wireless packet can be transmitted after the first wireless packet and before the second wireless packet.

As shown in FIG. 3, an embodiment of the present invention aligns data frames with wireless packets in a data streaming process that operates on consecutive data frames. For example, continuing from the above operation on a first data frame, a second data frame can be divided into a plurality of data frame portions, including a first data frame portion and an ending data frame portion. The first data frame portion of the second data frame comprises the temporal beginning of the second data frame. The first data frame portion of the second data frame is inserted into a third wireless packet and fills the third wireless packet. The third wireless packet is transmitted over the wireless link. The ending data frame portion of the second data frame is inserted into a fourth wireless packet. If the ending data frame portion of the second data frame by itself does not fill the fourth wireless packet, then fill data is inserted into the fourth wireless packet sufficient to fill the fourth wireless packet. The fourth wireless packet is then transmitted over the wireless link.

In a further aspect of the present invention, a uniform wireless packet size is required in streaming data over the wireless link, as represented in FIG. 3 by the uniform sizes of the wireless packets. In addition, as is often the case, the data frames are greater in size than the uniform wireless packet size.

In a further aspect of the present invention, the streaming data scheme prohibits re-transmission of frames over the wireless link, which is often the case with wireless systems. In addition, the wireless link may not include a control channel.

With reference to FIG. 3, another embodiment of the present invention reduces errors in streaming data over a wireless link by aligning a start of a data frame (e.g., video frame 1) with a first wireless packet (e.g., wireless packet 1), transmitting a beginning portion of the data frame in the first wireless packet over the wireless link, inserting into a second wireless packet (e.g., wireless packet 2) an ending portion of the data frame along with fill data sufficient to fill the second wireless packet, and transmitting the second wireless packet over the wireless fink.

FIG. 4 illustrates another embodiment of the present invention, which divides a video frame into video frame segments that each fit within a single wireless packet, and uses synchronization markers to align each video frame segment with its wireless packet. Fill data is inserted as necessary to align the end of a video frame segment with the end of its wireless packet. As shown in FIG. 4, multiple synchronization markers are used in streaming the video frames. Each video frame is split up into smaller video frame segments so that each, together with its synchronization marker, fits within one wireless packet. For example, as shown in FIG. 4, video frame 2 is subdivided into three segments, video frames 2.1, 2.2, and 2.3. The synchronization markers are inserted at the wireless link packet boundaries. Optionally, additional markers can be added throughout a wireless packet to provide additional means for correcting errors in a packet.

The synchronization markers are unique for each video frame segment so that a decoder on the receiving end is able to uniquely identify exactly which segment of the video frame has been received with an error. This identification helps the decoder recover more quickly from a wireless packet loss. As a result, a partial video frame can be recovered and the loss of a single wireless packet can only cause an error in a single video frame or partial video frame.

With reference to FIG. 4, an embodiment of the present invention reduces errors in streaming data over a wireless link by aligning a start of a data frame (e.g., data frame 1) with a first wireless packet (e.g., wireless packet 1), dividing the data frame into a plurality of portions including a beginning portion (e.g., data frame segment 1.1) and an ending portion (e.g., data frame segment 1.2), inserting a first synchronization marker in the beginning portion and a second synchronization marker in the ending portion, transmitting the beginning portion of the data frame in the first wireless packet over the wireless link, inserting into a second wireless packet the ending portion of the data frame along with fill data sufficient to fill the second wireless packet, and transmitting the second wireless packet over the wireless link. In a further aspect, the unique identification of a synchronization marker is used to identify exactly which segment of the video frame has been received with an error.

In a further embodiment of the present invention, the error reduction processes of FIGS. 3 and 4 are used in combination with each other.

In addition to the exemplary video frames shown in FIGS. 3 and 4, the present invention could be used with other data transmitted over a wireless link, such as audio frames or combination audio/video frames. Therefore, notwithstanding the particular benefits of applying data and wireless frame alignment to reduce video transmission errors, the present invention should be considered broadly applicable to any data transmission over a wireless link, system, or network. Indeed, wireless systems transmitting real-time streaming digital content, such audio and video data, often have fixed data packet sizes and do not have access to the same re-transmission and variable data packet sizes that are available with other transmission systems, such as the Internet. Therefore, the present invention is uniquely suited to minimize the effects of wireless transmission errors.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method for reducing errors in streaming data over a wireless link, the method comprising:
dividing a data frame into a plurality of data frame portions, wherein a first data frame portion of the plurality of data frame portions comprises the temporal beginning of the data frame;
inserting the first data frame portion into a first wireless packet, wherein the first data frame portion fills the first wireless packet;
transmitting the first wireless packet over the wireless link;
inserting an ending data frame portion of the data frame into a second wireless packet;
inserting fill data into the second wireless packet sufficient to fill the second wireless packet if the ending data frame portion by itself does not fill the second wireless packet; and
transmitting the second wireless packet over the wireless link.

2. The method of claim 1, further comprising:
dividing the data frame into the first data frame portion, an intermediate data frame portion, and the ending data frame portion;
inserting the intermediate data frame portion into a third wireless packet, wherein the intermediate data frame portion fills the third wireless packet; and
transmitting the third wireless packet over the wireless link.

3. The method of claim 2, wherein the third wireless packet is transmitted after the first wireless packet and before the second wireless packet.

4. The method of claim 1, further comprising:
dividing a second data frame into a plurality of data frame portions, wherein a first data frame portion of the second data frame comprises the temporal beginning of the second data frame;
inserting the first data frame portion of the second data frame into a third wireless packet, wherein the first data frame portion of the second data frame fills the third wireless packet;
transmitting the third wireless packet over the wireless link;
inserting an ending data frame portion of the second data frame into a fourth wireless packet;
inserting fill data into the fourth wireless packet sufficient to fill the fourth wireless packet if the ending data frame portion of the second data frame by itself does not fill the fourth wireless packet; and
transmitting the fourth wireless packet over the wireless link.

5. The method of claim 1, wherein the data frame is a video frame.

6. The method of claim 1, further comprising:
inserting a first synchronization marker at the beginning of the first data frame portion; and
inserting a second synchronization marker at the beginning of the ending data frame portion.

7. The method of claim 1, further comprising:
dividing a second data frame into a plurality of data frame segments, wherein the plurality of data frame segments includes a first data frame segment and an ending data frame segment;
inserting a first synchronization marker and the first data frame segment into a third wireless packet, wherein the synchronization marker marks the temporal beginning of the third wireless packet;
inserting a second synchronization marker and the ending data frame segment into a fourth wireless packet, wherein the synchronization marker marks the temporal beginning of the fourth wireless packet;
inserting fill data into the fourth wireless packet sufficient to fill the fourth wireless packet; and
transmitting the third wireless packet and the fourth wireless packet over the wireless link.

8. The method of claim 1, further comprising requiring a uniform wireless packet size for streaming data over the wireless link, wherein the first wireless packet and the second wireless packet are equal in size to the uniform wireless packet size, and wherein the data frame is greater in size than the uniform wireless packet size.

9. The method of claim 1, further comprising prohibiting re-transmission of frames over the wireless link.

10. The method of claim 1, wherein the wireless link does not include a control channel.

11. A method for reducing errors in streaming data over a wireless link, the method comprising:
aligning a start of a data frame with a first wireless packet;
transmitting a beginning portion of the data frame in the first wireless packet over the wireless link;
inserting into a second wireless packet an ending portion of the data frame along with fill data sufficient to fill the second wireless packet; and
transmitting the second wireless packet over the wireless link.

12. The method of claim 11, wherein the beginning portion starts with a first synchronization marker and the ending portion starts with a second synchronization marker.

13. The method of claim 12, further comprising using one of the first synchronization marker and the second synchronization marker to identify a wireless packet received with an error.

14. The method of claim 11, further comprising requiring wireless packets transmitted over the wireless link to be of a uniform size, wherein the data frame is greater in size than the uniform size.

15. The method of claim 11, further comprising transmitting over the wireless link an intermediate portion of the data frame in a third wireless packet, wherein the intermediate portion fills the third wireless packet.

16. The method of claim 11, wherein the streaming data comprises video data, wherein the data frame comprises a video frame, and wherein the method further comprises prohibiting re-transmission of video frames over the wireless link.

17. The method of claim 11, wherein the beginning portion fills the first wireless packet.

18. The method of claim 11, further comprising:
aligning a start of a second data frame with a third wireless packet;
transmitting a beginning portion of the second data frame in the third wireless packet over the wireless link;
inserting into a fourth wireless packet an ending portion of the second data frame along with fill data sufficient to fill the fourth wireless packet; and
transmitting the fourth wireless packet over the wireless link.

19. A method for reducing errors in streaming video data over a wireless link, the method comprising:
requiring wireless packets transmitted over the wireless link to be of a uniform size;
aligning a start of a video frame with a start of a first wireless packet, wherein the video frame is greater in size than the uniform size;
transmitting over the network a beginning portion of the video frame in a first wireless packet;
inserting an ending portion of the video frame into a second wireless packet;
inserting fill data into the second wireless packet sufficient to fill the second wireless packet;
transmitting over the wireless link the second wireless packet containing the ending portion of the video frame and the fill data; and
prohibiting re-transmission of wireless packets over the wireless link.

20. The method of claim 19, further comprising inserting a synchronization marker at the beginning of each of the beginning portion and the ending portion of the video frame.
